(19) United States
(12) Patent Application Publication
(10) Pub. No.: US 2004/0140888 A1
(43) Pub. Date: Jul. 22, 2004

(54) Low air pressure warning system for tires

(76) Inventor: William A. Simpson, Reseda, CA (US)

Correspondence Address: William A. Simpson, 7241 Yolanda Ave., Reseda, CA, 91335, US

(21) Appl. No.: 10/701,983

(22) Filed: Nov. 6, 2003

Related U.S. Application Data
(60) Provisional application No. 60/424,875, filed on Nov. 12, 2002.

(51) Int. Cl. B60C 23/00

(52) U.S. Cl. 340/442; 73/146; 116/34 B

(57) ABSTRACT

A device for sensing the degree of flexing in a tire. When the flexing of a tire due to low air pressure has reached a dangerous point, this device will warn the driver that this tire requires immediate attention. The driver will then add make up air or if the tire is damaged the driver will replace it.

### CROSS REFERENCE TO RELATED APPLICATIONS

NOT APPLICABLE.

### STATEMENT REGARDING FEDERALLY SPONSORED RESEARCH OR DEVELOPMENT

NOT APPLICABLE

Reference to a “microfiche appendix”.

Not applicable.

### TECHNICAL FIELD.

1. Field of Invention

This invention relates to maintaining safe air pressure in tires.

Low tire pressure with excessive flexing and overheating will destroy the bonding between parts of a tire. Tread separation from the tire followed by a blowout will sometimes occur.

2. Background Art

With low air pressure, the height of the wheel above the ground will decrease.

The distance between the rim of the wheel and the interior of the tire above the tire-road interface will decrease.

This invention will warn the driver of a vehicle when this distance has dropped to a critical point at which excessive flexing of the tire may occur.

The danger of operating vehicles on tires with low air pressure has prompted the government to mandate low air pressure alarms on most vehicles within a few years.

### BRIEF SUMMARY OF THE INVENTION

This invention relies on a sensor-switch supported in the tire air space by a probe extending from the rim of the wheel into the tire air space.

With low tire pressure, the sensor-switch on the end of the probe will be closed as it contacts the interior of the tire above the tire-road interface. This contact will occur momentarily with each revolution of the wheel.

When the sensor-switch contacts the interior of the tire, the sensor-switch will close. The driver alarm system will be energized.

The driver alarm will sound when tire air pressure has decreased about 25% from normal.

### BRIEF DESCRIPTION OF THE DRAWINGS

FIG. 1 and FIG. 2 numerical designations.

1. Tire interface with road.

2. Sensor-switch.

3. Spring.

4. Base.

5. Module consisting of transmitter and battery.

6. Rim of wheel.

Wire connecting sensor-switch to negative battery (not shown)

Wire connecting sensor-switch to transmitter (not shown)

Wire connecting positive battery to transmitter (not shown)

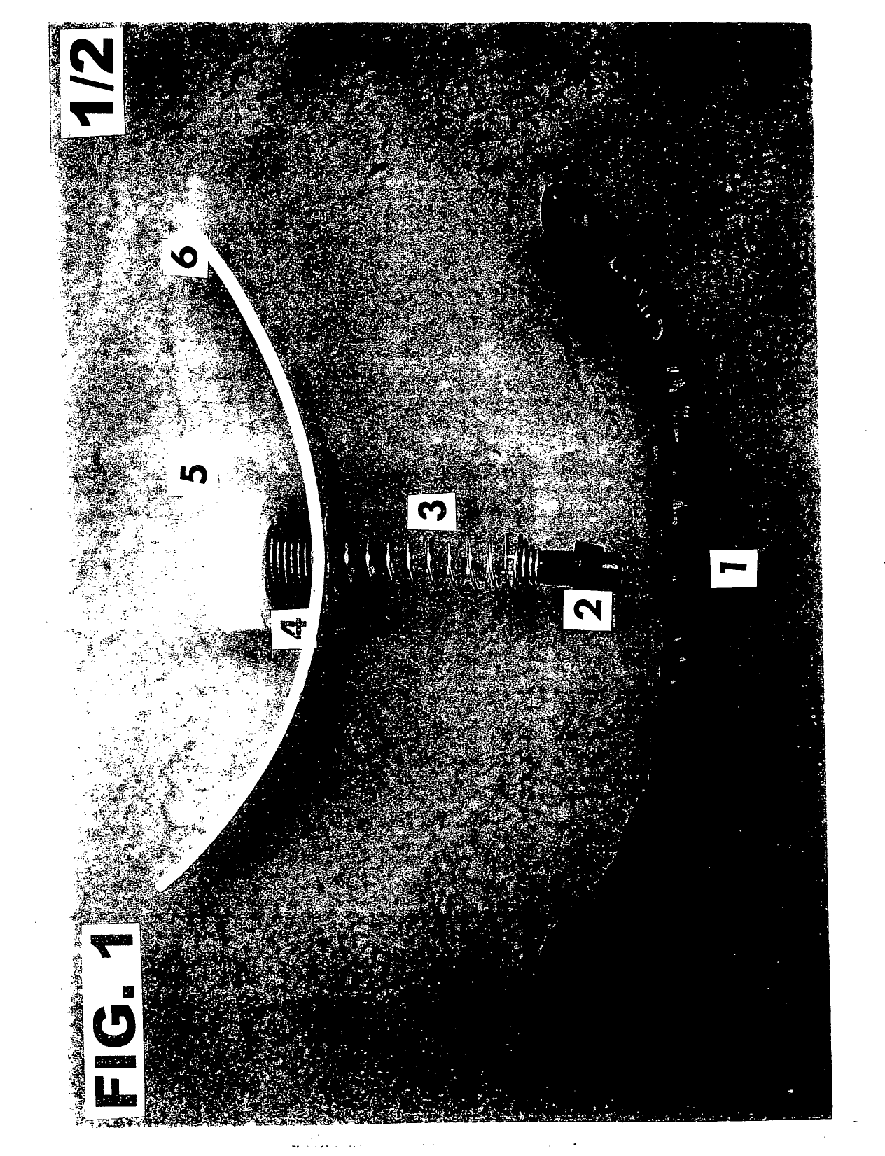

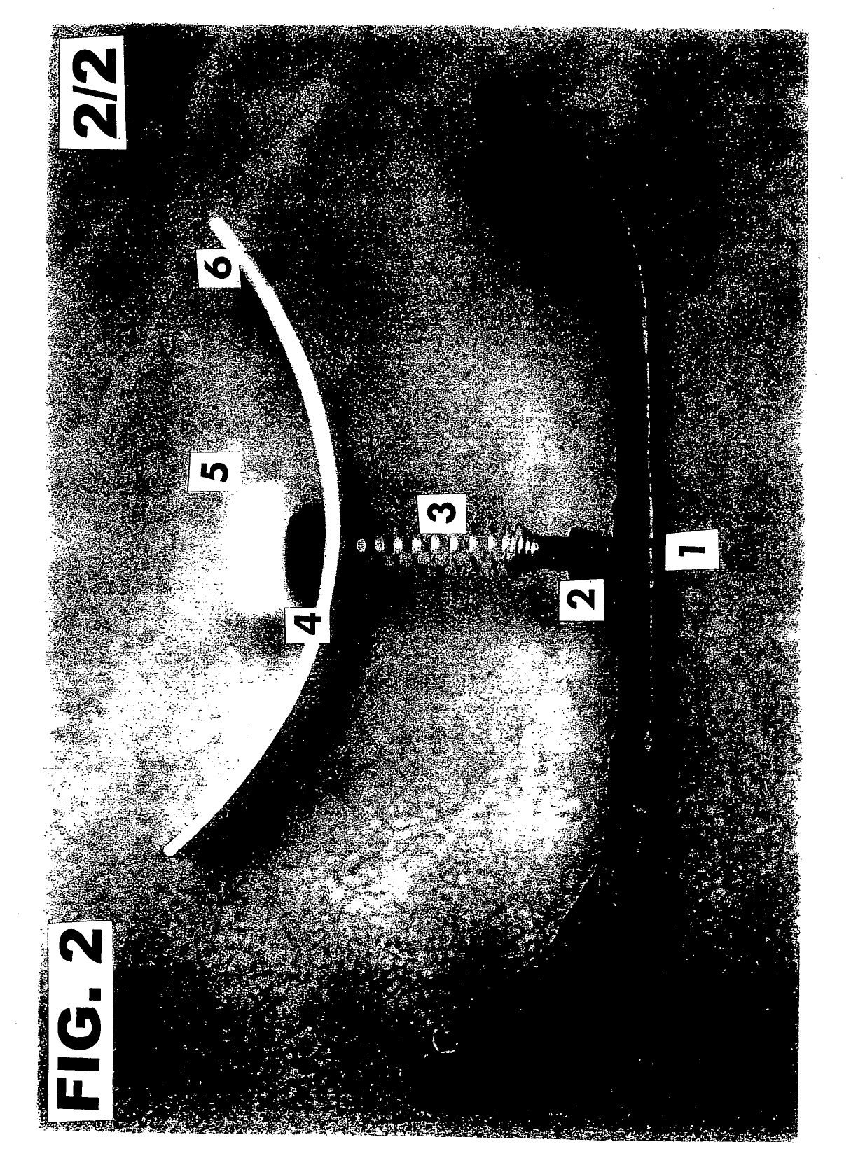

The FIGS. 1 and 2 are schematic. In practice the probe would be of a heavy construction. The spring would be strong enough to withstand lateral forces during travel on rough roads and during acceleration and braking of the vehicle.

The purpose of the spring is to provide longitudinal flexibility as the sensor-switch contacts the interior of the tire above the tire-road interface. This contact will occur once each revolution of the wheel with low air pressure in the tire.

### DETAILED DESCRIPTION OF THE INVENTION

This invention consists of a probe which is threaded through the rim of the wheel 5 into the tire air space. The end of the probe supports a push-button type sensor-switch 2 which closes upon contact with the interior of the tire above the tire-road interface.

This contact will occur with low tire pressure as the height of the wheel rim above the tire-road interface 1 decreases.

With a 25% drop in air pressure, the sensor-switch 2 will contact the interior of the tire above the tire-road interface 2. This contact will take place once during each wheel revolution.

As the sensor-switch 2 closes, the transmitter in module 5 will be energized.

A signal will be sent to a receiver-alarm (not shown) on the dash of the vehicle.

The alarm will sound and a light on the dash indicating the tire with low pressure will be energized.

The driver will be aware immediately of low air pressure in the tire.

a. a warning device to alert the driver of a vehicle to low air pressure in a tire, comprising:

b. a probe mounted on the rim of a wheel and extending into said tire air space, a sensor-switch located at the end of said probe to enable said sensor-switch to contact the interior of said tire above the tire-road interface once during each revolution of said wheel should the air pressure of said tire drop to a dangerous level,

c. means to provide an alarm for said driver as said sensor-switch contacts the interior surface of said tire and closes during low air pressure,
whereby said driver will be alerted to the excessive flexing of said tire due to low air pressure.
